(19) United States
(12) Patent Application Publication
(10) Pub. No.: US 2009/0271322 A1
(43) Pub. Date: Oct. 29, 2009

(54) Electronic receipt system and method

(76) Inventors: Isaac Lay, Brea, CA (US); Joseph Silla, La Mirada, CA (US); Dusty Schlabach, Fullerton, CA (US)

Correspondence Address: KLARQUIST SPARKMAN, LLP, 121 SW SALMON STREET, SUITE 1600, PORTLAND, OR, 97204, US

(21) Appl. No.: 12/150,355

(22) Filed: Apr. 28, 2008

(51) Int. Cl. G06Q 99/00; H04L 9/32

(52) U.S. Cl. 705/75; 705/21

(57) ABSTRACT

A system and method for auto generating an electronic receipt from virtually any type of public facing business having a live point-of-purchase and utilizing an electronic payment systems, namely, a point-of-sale (POS) system having a credit card terminal and/or an electronic cash registers (ECR). The system includes a software add-on which authenticates and identifies consumers at the POP using a pre-registered credit/debit card, deactivates normal receipt printing functionality, captures electronic receipt information and transmits this information to a membership or subscriber based Internet web-site, where consumers may then view and manage the information. The system can be used to automate a product return and/or generate and transmit a gift receipt. The system further includes a membership or provider based Internet website for merchants to view and manage information related to previous customers, from which merchants may distribute coupons and/or advertisements to these consumers.

### FIELD OF THE INVENTION

The present invention relates generally to the automatic capture, generation and transmission of an electronic receipt from a point-of-purchase. More specifically, the invention relates to a web based service wherein users/subscribers receive electronic receipts generated at a point-of-purchase and stored remotely for future viewing. Further, users/subscribers are identified at the point-of-purchase through a pre-registered credit/debit card or phone number for electronic receipt delivery to user/subscribers account.

### BACKGROUND OF THE INVENTION

The advent of electronic or on-line shopping has led to the issuance of electronic receipts in a computer readable format. These receipts are usually provided upon completion of an on-line transaction and may be viewed and printed by the user directly from his/her computer terminal and a peripheral printer. Alternatively, an electronic receipt may be sent to the user electronically, via e-mail, for him/her to view and print out from a different computer at a later point in time.

Unfortunately, in point-of-purchase situations paper receipts are still used. More specifically, all types of merchants, banks, retailers, and service providers issue paper receipts for the various types of financial transactions, services and/or purchases which they might provide at specific point-of-purchase locations. For example, a restaurant will issue a paper receipt for a user regardless of whether the user pays with cash and/or credit. Similarly, department stores, food stores and various retail outlets will also issue a paper receipt at the time of purchase, regardless of the form or method of payment.

Use of paper receipts is outdated and represents a myriad of pitfalls and problems. First and foremost, the environment costs and concerns involved in the use of paper receipts is altogether immeasurable. Second, paper receipts are often lost, misplaced, or accidentally disfigured or destroyed. Third, paper receipts, even when stored in a safe and secure environment, tend to age and fade over time, making them entirely useless.

Accordingly, it is desirable to have a secure working paperless receipt system which can provide a secure electronic receipt for any transaction executed at any remote point-of-purchase location from any retail business anywhere in the world. Additionally, it is desirable to have a single, centrally located web based service for the delivery of all electronic receipts from every physical retail establishment in order to simplify the process for consumer's accessing their electronic receipt data. It is further desirable for these receipts to be electronically delivered, stored and easily retrieved by a user, from any remote computer location via the Internet.

### SUMMARY OF THE INVENTION

The present invention is for a system and method for auto capturing and auto generating an electronic receipt from virtually any type of public facing business having a live point-of-purchase, provided that business uses and accepts electronic payment systems, namely, point-of-sale (POS) systems such as a credit card terminal and/or electronic cash register (ECR) which may further include a cash drawer, barcode scanner, receipt printer, customer facing payment terminal, touch screen, and other similar devices known in the art.

The system includes a software add-on which is integrated into the POS electronic payment system and which may be used to enroll a new user and/or authenticate/identify a user through a previously registered credit/debit card number, biometric sample, phone number or email address. The software add-on will deactivate receipt printing functionality at the POP, transmit electronic receipt information to a membership or subscriber based Internet web-site where it is stored in the user's account, and accept incoming product return data from a remote server/database to facilitate a product return.

The system further includes a membership or provider based Internet website for merchants to view and manage information related to electronic receipts generated from purchases of previous customers. A consumer/user may then view and manage their individual electronic receipts at any time from a local Internet-ready computer terminal. This website will also preferably allow subscriber merchants to distribute coupons and advertisements to these consumers.

The system further includes an Internet website that allows business customers to create and manage expense reports and export expenditures into accounting software.

In a preferred embodiment, the system of the present invention facilitates communications between a POP and a remote server/database location via a custom software add-on which is integrated into the POS electronic payment system resident at the POP. As a result of this integration, and as a function of the custom software integrated into the POS electronic payment system, a merchant is able to communicate with the server/database to identify and authenticate a consumer/subscriber via their credit/debit card, phone number or email address entered at the POP by consumer/cashier and generate an electronic receipt which is stored within the server/database location and which may be viewed by a consumer/subscriber at a later, more convenient time. The system can also transfer a copy of the receipt directly to the consumer/subscriber via e-mail or text message.

### BRIEF DESCRIPTION OF DRAWINGS

FIG. 1 illustrates a preferred embodiment for a system of the present invention;

FIG. 2 illustrates a flow chart for the steps taken in an on-line or Internet enrollment of a consumer/purchaser type client into the system of the present invention;

FIG. 3 illustrates a preferred embodiment for a typical enrollment or registration webpage which provides an array of fields in which a new user will enter personal, demographic information;

FIG. 4 illustrates a flow chart which shows the steps executed when enrolling a consumer/purchaser directly on site from a POP location.

FIG. 5 illustrates a flow chart for the steps taken in for enrollment of a POP merchant/seller location into the system of the present invention;

FIG. 6 illustrates a flow chart which shows the steps for generating and storing an electronic receipt using the system of the present invention;

FIG. 7 illustrates a preferred embodiment for a listing of receipt headers for various purchases/transactions which will be visible to a subscribing consumer/purchaser when he/she accesses their account; and

FIG. 8 illustrates a preferred embodiment for a sample electronic receipt generated by a system of the present invention.

### DETAILED DESCRIPTION OF PREFERRED EMBODIMENTS

The present invention is for a system and method for auto generating an electronic receipt from virtually any type of public facing business having a live point-of-purchase, provided that such business uses and accepts electronic payment systems, namely, point-of-sale (POS) electronic payment systems such as a credit card terminal and/or electronic cash register (ECR) which may further include a cash drawer, barcode scanner, receipt printer, customer facing payment terminal, touch screen, other similar point-of-sale peripherals known in the art.

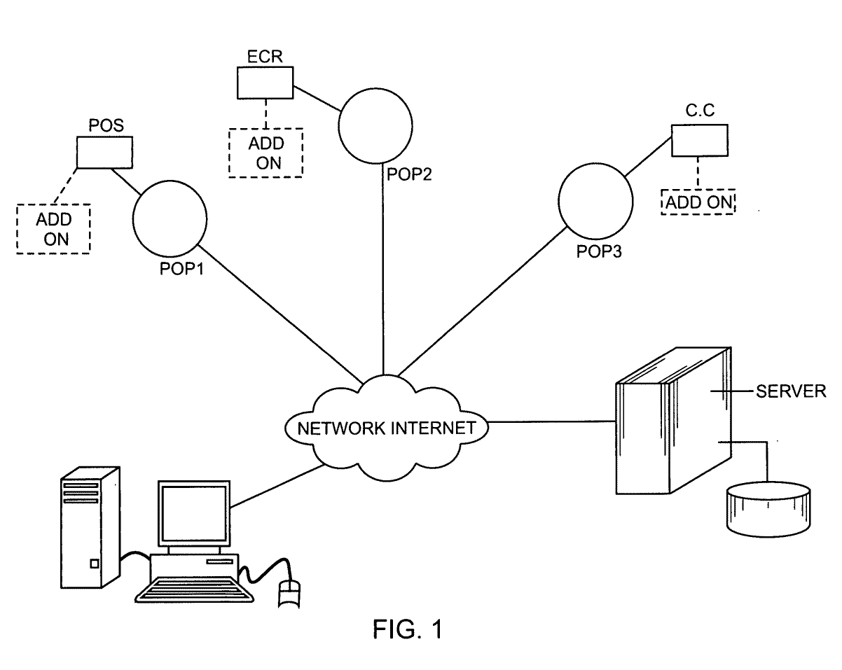

FIG. 1 illustrates a preferred embodiment for a system of the present invention. As shown in FIG. 1, the system includes a number of point-of-purchase locations for a plurality of merchant businesses and stores and/or service providers. Each point-of-purchase location utilizes some type of POS electronic payment system, such as a credit card terminal (CC) and/or an electronic cash register (ECR), which may also further include a cash drawer, barcode scanner, receipt printer, customer facing payment terminal, touch screen, etc.

The POS electronic payment system at each POP merchant location is preferably equipped with a custom software add-on which is integrated into the POS electronic payment system at the merchant's POP location. This software performs/enables many of the functions described in greater detail further hereinafter.

The system further includes a remote membership or subscriber based Internet server/database location which is in communication, preferably via the Internet, with each individual merchant POP location via the POS electronic payment system and the custom software add-on resident at that location. As will be described in further detail hereinafter, the remote membership or subscriber based Internet server/database location provides a network accessible web-site (e.g. via the Internet) where consumers may view and manage their individual electronic receipts from any remote location using a computer terminal/keyboard having Internet access.

As illustrated in FIG. 1, the system of the present invention facilitates communications between each individual POP and the remote Internet server/database location via a custom software add-on which is preferably integrated into the POS at the merchant location. The custom software add-on is used to acquire receipt data from customer transactions in order to generate an electronic receipt which is transmitted and stored at the remote Internet server/database location. These receipts may be viewed by a consumer/subscriber at a later, more convenient time. In a preferred embodiment, the remote Internet server/database location can be configured to transfer a copy of the receipt directly to the consumer/subscriber via e-mail or text message.

### Enrollment/Subscription

As indicated earlier herein, the system of the invention is a subscriber/user based system which preferably serves two types of clients, merchants and consumers/purchasers. Clients may subscribe via a webpage preferably available over the Internet, although other modes of subscription are possible—such as over the telephone and/or a live enrollment of a consumer/purchaser type client directly from a POP location equipped with an POS electronic payment system and the custom software add-on. Each client type must be a subscribing member and the enrollment process for each is different. The various enrollment/subscription methods are now discussed in further detail.

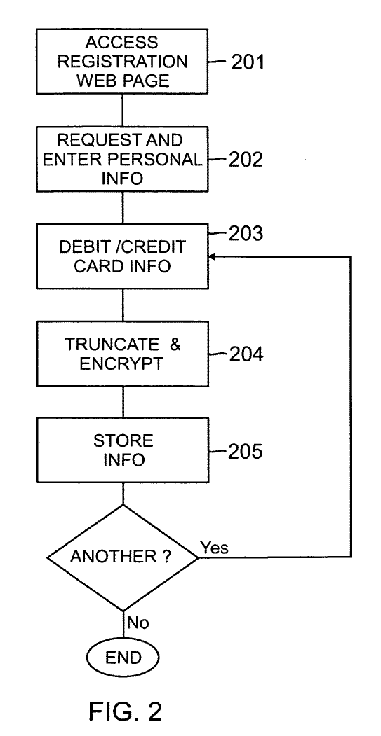

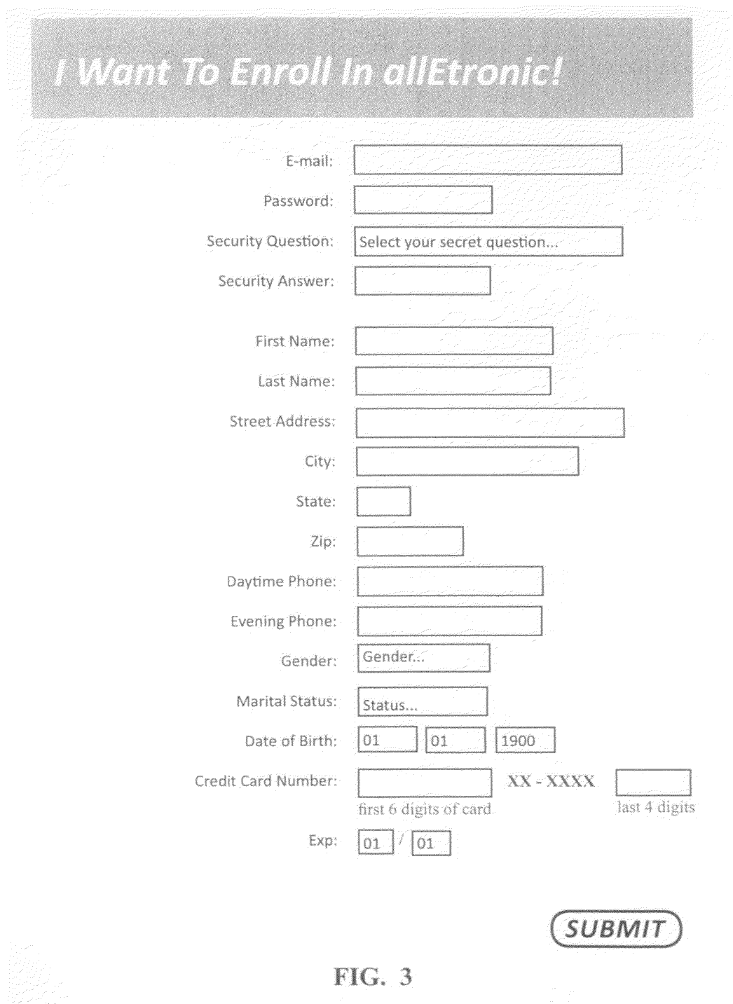

FIG. 2 illustrates a flow chart for the steps taken in an on-line or Internet enrollment of a consumer/purchaser type client. During typical webpage/on-line enrollment of a consumers/purchaser type client, the consumer/purchaser will access the remoter server/database location via the Internet and pull up a registration web page using a computer terminal/keyboard which has Internet access 201. The registration web page is preferably configured to request an array of personal, demographic information from the new enrollee (the consumer/purchaser client) such as his or her name, address, and telephone number 202. FIG. 3 illustrates a typical enrollment or registration webpage which provides an array of fields of which a new user will enter personal, demographic information such as his or her name, address, and telephone number. The individual consumer/purchaser client will enter this information from his/her local computer terminal/keyboard.

Referring again to FIG. 2, the system is also preferably configured to request that the consumer/purchaser enter at least one credit/debit card number which he or she wishes to have linked to their account 203. The user will enter the credit or debit card number, and three or four digit security code appearing on the card, and an expiration date.

The system of the present invention preferably uses a proprietary truncation and encryption algorithm to truncate and encrypt the card number and store the result (along with the other identifying information previously entered) in a database under the subscriber's/purchaser's account 204. It should be noted that at no time is the actual credit card number ever stored, even though certain security measures may be taken to facilitate the secure storage of a full credit card number. Only the end result of the truncation/encryption operation is stored at the remote server/database location 205.

Upon enrollment, enrollee's may link as many credit or debit cards to their account as they want. A business owner, for example, could link both her personal debit/credit card(s) and her business debit/credit card(s) to the same account, thus making the tracking of both personal and business card based transactions (and related receipts) much easier.

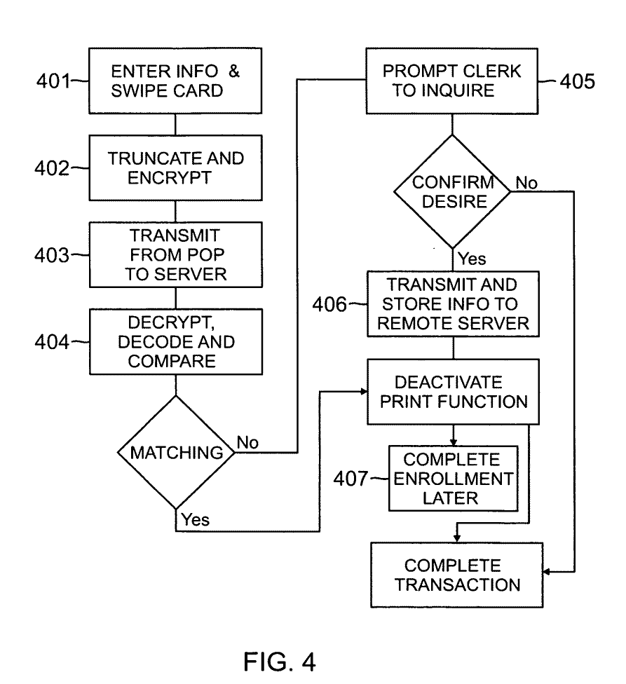

As explained earlier, the system also provides for live enrollment of a consumer/purchaser type client directly from a POP location equipped with a POS electronic payment system and the custom software add-on. FIG. 4 illustrates a flow chart which shows the steps executed when enrolling a consumer/purchaser directly on site from a POP location. In this situation, a new consumer account can be created by a cashier directly at the POS system by first entering the customer's phone number and/or email address, and then swiping the customer's credit/debit card 401.

Once the credit or debit card is swiped, the card information is truncated and encrypted by the software add-on at the POP 402 and the truncated/encrypted card info, along with the phone number and/or e-mail address, is transmitted from the POP location to the remote server/database location, where the information is then decrypted and compared to previously stored information 403, 404.

If there is no matching entry, a signal will be returned to the clerk/cashier at the POP, prompting him/her to inquire as to whether the purchaser/consumer wishes to become a member in to the system and thereafter begin receiving electronic receipts 405. If the user affirms the intent to become a member, the clerk/cashier will confirm this intent and a return/confirmation signal will be transmitted from the software add-on at the POP to the remote server/database location so the customers phone and/or e-mail and credit/debit card number may be stored 406.

If only a phone number was entered or provided to the cashier, an automated system will call the customer 2-3 days after their purchase and remind them to log into the remote server/database using their own local home computer terminal/keyboard to that they may finalize the enrollment process by visiting the website 407. Similarly, if only an email was entered or provided to the cashier: an automated email may be sent to the customer immediately after their purchase reminding them to log into the remote server/database using their own local home computer terminal/keyboard to that they may finalize the enrollment process by visiting the website 407.

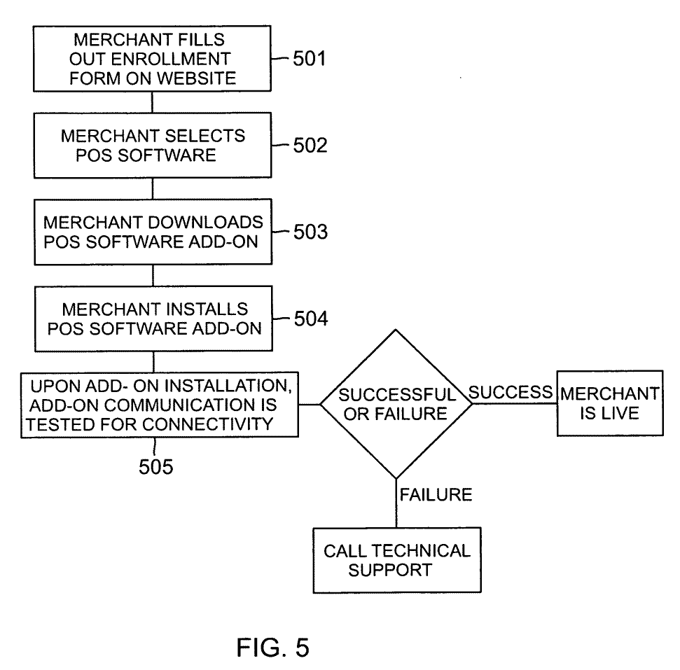

As explained earlier herein, the system of the present invention also provides member merchants with their own accounts where information about various purchasers may be stored. This information will allow merchants to target specific consumers with coupons or advertising based upon their prior purchasing behavior/information. FIG. 5 illustrates a flow chart for the steps taken in for enrollment of a POP merchant/seller location into the system of the present invention. As shown, a merchant will access the remote server/database location via the Internet and pull up a merchant subscriber registration web page which must be completed by the merchant 501. Much like the consumer user webpage, this will ask the merchant to provide certain demographic information. As will be discussed later herein, this information will include details about the products/services offered by the merchant in order to categorize receipts generated from the merchant's POP location.

The merchant then selects a customized software-add on for their POS system 502. Preferably, the software add-on may come in several options depending upon the particular POS system used by the merchant at their POP location. This software add-on is downloaded to the merchants POS system from the remote server/database location 503 and installed within the merchant's POS system for operation 504.

Once the software add-on has been successfully selected, downloaded and installed, the software will run a trial connection and attempt to communicate with the remote server/database location in order to ensure that it is operating properly 505. If the trial connection is successful and the software add-on is running properly then the merchant is connected within the network and fully operational. If the trial connection is unsuccessful, an error message will be returned and the merchant will be instructed to call technical/customer support in order to debug/address the issue and ensure proper connection and operation of the software add-on.

### Generating Electronic Receipts

Upon enrolling, the system of the present invention provides consumer/purchaser members with a whole host of services including the generation, transmittal, storage and retrieval of electronic receipts as well as the ability to initiate a return from virtually any type of public facing business having a live point-of-purchase, provided that business uses and accepts electronic payment systems, namely, a point-of-sale (POS) system having a credit card terminal and/or electronic cash register (ECR) which may optionally further include a cash drawer, barcode scanner, receipt printer, customer facing payment terminal, touch screen, and/or other peripheral devices.

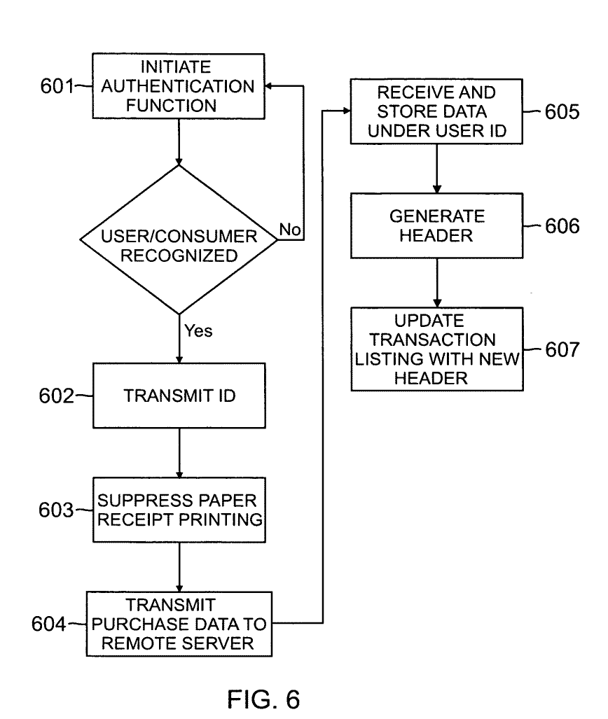

FIG. 6 is a flow-chart which illustrates operation of the system in generating and storing electronic receipts/receipt information, in accordance with a preferred embodiment of the present invention. As shown in FIG. 6, when a consumer who is a subscriber to the system of the present invention engages in a transaction at a participating business, the add-on software will initiate an authentication function to ensure that the user is a subscriber/member to the system 601. More specifically, when a consumer initiates a transaction at a POP, a clerk or attendant, or even the customer themselves will either manually enter some identifying information such as a user's telephone number and/or e-mail address into the customer facing payment terminal or device; or, the clerk/attendant/customer will swipe the consumer's credit or debit card. The custom software add-on integrated into the POS electronic payment system will then utilize this information to authenticate the consumer as follows:
If a phone number or email address is entered by the clerk/attendant/consumer at the POP using a keyboard, customer facing payment terminal, or any other device known in the art, this information is transmitted to the remoter server/database location where a conventional search (utilizing techniques well known in the art) is then conducted to compare the information input by the clerk/attendant/consumer with information stored at the remote server/database location in order to see if the consumer is indeed a subscriber member with an active account.
If a credit card is swiped at the POS location, or waived in front of a RFID receiver, as in the case of contactless enabled credit cards, the card number is truncated and encrypted and the result is transmitted from the POS to the remoter server/database location in order to identify the consumer and link the electronic receipt transaction to their account. At the remote server/database location, the encrypted/truncated card number is decrypted. The truncated card number is then compared with the truncated results previously stored in order to match the user to his/her account.

Other authentication methods are possible and are within the spirit and scope of the invention. Such methods may include a magnetic strip, barcode or RFID chip enabled membership card which the user might swipe, scan or wave using a credit/debit card reader at the POP while engaging in the transaction, a secure pin number which the user might enter while engaging in a transaction at a POP, or a biometric identifier such a fingerprint which might be scanned at the POP and then transferred to the remote server/database location for verification.

Once the user has been authenticated, the remoter server/database location return transmits a Consumer ID to the POS electronic payment system at the POP 602, informing the software add-on within the POS electronic payment system of a successful authentication/validation. The custom software add-on will then initiate a set of procedures and/or instructions for generating and transmitting an electronic receipt.

First, the POS software add-on instructs the POS electronic payment system to suppress printing of a paper receipt 603, thus any printer coupled to the POS electronic payment system will be prevented from printing a receipt. The software add-on at the POP will then package and transmit specific purchase information related to the purchase to the remoter server/database location 604 (this information will include the Merchant ID, the Consumer ID, Date, Time, Item Purchased & Price (for each individual item), the Subtotal, Shipping Charges (if applicable), Tax, Discounts (if applicable), Grand Total, Payment Method, Payment Amount, and Change Returned). This information is received at the remote server/database location and stored in the consumer/member's individual account for future use/reference 605.

Upon enrolling in the system of the present invention, consumers will be given at least five (5) standard category/folders in which the receipt data for each transaction will be stored. This feature allows a consumer to more effectively track their spending as it relates to their unique or typical household purchases. These standard categories, which can easily be customized and changed, will preferably include: General, Utilities, Household, Food, & Entertainment. When a specific merchant or POP location becomes a provider under the system, the system will categorize that business and/or its goods and services into one or multiple categories or business type identifiers which are directly related to these standard categories. Thus when receipts are generated and transmitted from member merchants' POP locations, they can be matched up to and stored within a consumer/purchaser's individual account under one of these categories/folders.

Alternatively, consumers may create their own specific folders within their account. Accordingly, if a consumer wants to create a custom folder category within their account and link all their purchases from a particular business to said folder/category, they may do so. This will allow each consumer to more effectively track their spending.

### Consumer Portal

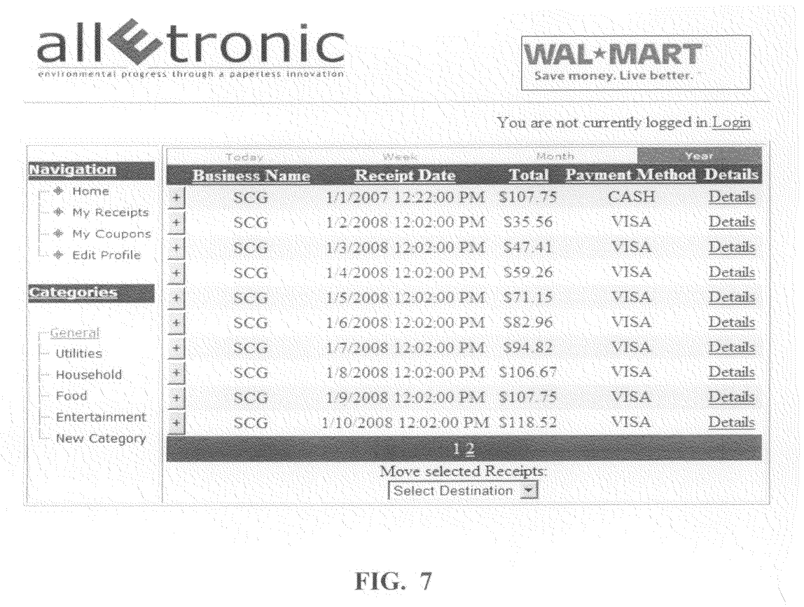

Upon receiving the information, the remote server/database will generate a single header line which will contain a select subset of this information 606. This will preferably include the Merchant ID, the Date, the Time, the Grand Total and the Payment Method. This header will then be displayed in a listing which is visible to the individual consumer/purchaser over the Internet whenever he/she logs into the account via the Internet from any remote computer terminal/keyboard location 607. In a preferred embodiment, the most recent account transactions are at the top of the listing, and the listing is configured to display the ten (10) most recent transactions. FIG. 7 illustrates a preferred embodiment for such a listing.

Accordingly, upon successful login subscribing consumers will be shown a listing of their ten most recent transactions for any of the debit or credit cards linked to the account. Users may select any of the items on the list in order to view more specific receipt details for that particular purchase/transaction. More specifically, using their remote computer terminal/keyboard, a user may scroll through the listing of their recent transactions in order to pull up a detailed receipt for that transaction. Alternatively, the system also includes various search functionalities. For example, in a preferred embodiment, users to the system have the option of searching a range of dates in order to retrieve receipts within that date range and/or searching for any and all receipts generated from transactions with a particular business or merchant (e.g. all receipts for purchases from BestBuy).

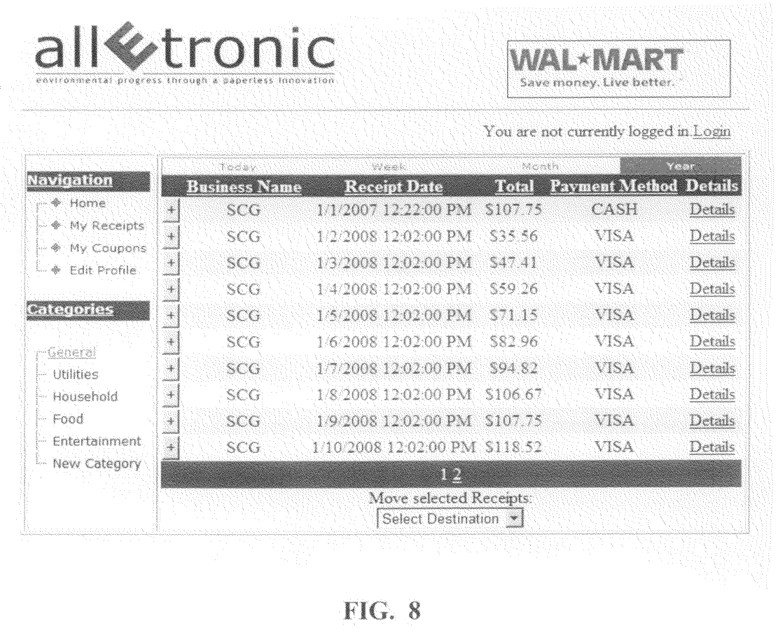

FIG. 8 illustrates the preferred embodiment for an individual receipt. Referring to FIG. 8 it shows specific purchase details for the first transaction shown in the listing of FIG. 7. These specific purchase details preferably include the individual items purchased (code and name/description), the quantity of each item purchased, the individual price, the shipping charges (if any), tax, discounts or coupons (if any) and the grand total for that particular transaction. The user is provided with a further option of printing a paper copy of the electronic receipt. If the user selects this option, the electronic receipt is downloaded to and printed by a local printer coupled to the user's computer terminal/keyboard.

The system of the present invention is configured to provide other user operations. For example, consumers will have the ability to (1) export receipt data into any accounting program of their choice, (2) add receipts from merchants that aren't members of our environmental network, initiate a product return or exchange with any merchant or POP member in the network, and/or (4) e-mail a gift receipts to a gift recipient void of associated dollar amount, or send it to a recipients account (provided that the recipient is a member to the system) using the recipient's name and phone number. These additional features are described in further detail hereinafter

(1) Export Receipts

Using this feature of the present invention, users are able to select receipt information for download and import into their financial accounting software. More specifically, users are able to search through their receipts using several parameters (e.g. a user can search for receipts given a range of dates, keywords, business name, business type, and/or even under pre-created receipt categories) and once the consumer has generated their report of receipts based on their search criteria, the software resident on the remote server/database will provide the user/consumer with an option of exporting any one or all of said receipts and downloading them to his/her local computer. After selecting this option to export their receipts, the consumer is given the names of several popular accounting programs (and associated file format extensions) to choose from. Based on the program selected, the receipt(s) are prepared/translated into the selected file format and then downloaded to the user/consumers local computer terminal (where they are then saved in an accounting program-friendly file format).

(2) Add Receipts

This feature allows a user to manually enter specific information in order to generate an electronic receipt for a purchase which might have been made at a merchant/retailer location not having a POS equipped with the software add-on of the present invention. More specifically, if a consumer obtains a paper receipt from a business/merchant that is not a member of the system and/or network of the present invention, the consumer will be able to login to their account and manually input receipt data from the paper receipt they were given. Alternatively, if the consumer has a scanner, they can easily scan the receipt, upload the jpg or gif, and assign and input basic tracking parameters to the image receipt such as category, business name, business type, and amount.

(3) Product Returns

This feature allows a user to initiate a product return process by auto-transmitted return information from the remote server/database to a desired merchant/retailer regarding an item(s) to be returned. More specifically, if a consumer wishes to make a return at a particular store for a specific product, they first need to locate the receipt containing the product they wish to return. There are many ways to do this. For example, if the consumer knows when they made their purchase, they can simply select a range of dates to see receipts from businesses within that time frame. Alternatively, if the consumer knows where they made their purchase, they may locate the respective receipt by searching using the business name.

Once the appropriate receipt has been located, the customer selects the line item on said receipt which corresponds with the item they wish to return. When they select the line item they are prompted with several options, including a ‘Return’ option. If the ‘Return’ option is selected, the remote server/database initiates an electronic communication with the store associated with the receipt from which the return item has been selected. The remote server/database will electronically contact the store that the purchase was made at and inform their POS system that this customer has initiated a product return. The customer then returns the items to the store/POP either in person or buy mail/shipment. Once the product is received at the store, they can match the returned product with the return information previously transmitted to the store. This will be particularly efficient when dealing with any retail return and also mail/shipment returns because the merchant/seller can very easily match the returned product with the receipt information and process the return much more quickly. This method returns allows the business to confirm with 100% certainty that the product was initially purchased at the store, thereby reducing the business risk of return fraud and enhancing the businesses loss prevention.

Once the store finalizes the return at the POP, the add-on software at the merchant's POP location will then preferably communicate the details of the updated receipt back to the remote server/database where this update receipt information is then stored to the consumer's individual account. Accordingly, within the consumers account, the user/consumer will see that the receipt shows an update and that the specific product has been returned.

(4) Gift Receipt

This feature allows a user to auto create and transmit a gift receipt to any recipient having a known e-mail or mailing address. More specifically, if a consumer wishes to send a gift receipt, the user first locates the original receipt upon which the “gift” purchase is indicated from the receipts stored at the remote server/database location under their individual account. Once that receipt has been located, the consumer can select the line item or items within that receipt which represent the “gift” purchased. Once selected, the user will be prompted by the remote server/database location with several options, including ‘Send as Gift’. If ‘Send as Gift’ is selected by the consumer, the consumer/user is then given two options for transmission of a gift receipt:

i) A gift receipt for those item(s) can be auto-generated by the software resident on the remote server/database using the selected information and this gift receipt can then be automatically transmitted from the remote server/database location to a specific email address entered by the user/consumer; or

ii) The user can attempt to locate and identify the recipient by inputting the email address of the recipient and the system can search to see if that e-mail is identified and associated with any other subscribing member/purchaser. If the system locates a match, the identity of the matching person (name and address) is presented for confirmation. If the user recognizes and confirms the name and address, a gift receipt is auto-generated by the system and this gift receipt is then transmitted to an e-mail or mailing address associated with that recipient's account.

### Merchant Portal

Merchant's typically implement rewards programs for the purpose of being able to track the spending habits of its customers. They typically attract consumers into their programs by offering product discounts for being a member. If a customer doesn't enroll in such a program, the merchant has no way of tracking that particular customer or the products they purchase. However, when a merchant becomes a subscribing member to the present system, they receive all types of information about the customers who patronize their business, provided, of course, that such customers are also enrolled into the system.

More specifically, after an enrolled consumer makes a purchase, the system of the present invention notifies the merchant of these consumer(s) and provides them with relevant consumer data which is transmitted from the POP to the remote server/database and stored in that merchant/provider's account for future use reference. The consumer information will include such things as items purchased and dates of purchase, as well as the customer's name, address and phone number. This information will allow merchants to track all data as it relates to a particular customer and their spending habits within their store(s). Merchants will be able to map customer data based on the frequency of their purchases.

Although preferred embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A system for generating and storing electronic receipt information, the system comprising:
a remote server/database for storing electronic receipt information and providing access thereto;
a point-of-sale electronic payment system, resident at a merchant's point-of-purchase, for capturing receipt data, deactivating the printing of a paper receipt and transmitting said electronic receipt information to the remote server/database;
wherein the electronic receipt information is truncated and encrypted before it is transmitted to said remote server database, and further wherein said electronic receipt information is decrypted before it is stored.

2. The system of claim 1, wherein the remote server database may be accessed by a subscribing consumer via the Internet, in order to retrieve the receipt information stored therein.

3. The system of claim 1, wherein a subscribing consumer may access the remote server database and use the receipt information stored therein to generate a paper receipt which may be downloaded to and printed on a local printer.

4. The system of claim 1, wherein the merchant may access the remote server database in order to retrieve an available subset of the receipt information, including information as to the purchaser's name, address, items purchased and e-mail or mailing address.

5. The system of claim 4, wherein the merchant may use the available subset of receipt information to track consumer purchases and provide electronic coupons.

6. The system of claim 1, wherein a subscribing consumer may access the remote server database and use the receipt information stored therein to generate a gift receipt, which may then be e-mailed to a gift recipient.

7. A system for generating and storing electronic receipt information, the system comprising:
a point-of-sale electronic payment system, resident at a point-of-purchase, for generating receipt information related to a transaction, said point-of-sale payment system being configured with a software add-on for receiving credit or debit card information from a purchaser for completing said transaction, and truncating/encrypting said credit or debit card information, thereby generating a result;
a remote server/database for providing subscription based access to electronic receipt information to consumers, said database being preloaded with membership information for each subscribing consumer, including truncated credit or debit card information;
wherein the point-of-sale electronic payment system is configured to transmit the result to the remote server/database, said result then being decrypted and compared to the preloaded truncated credit or debit card information for each subscribing consumer in order to verify whether the purchaser is a subscribing consumer; and
further wherein the point-of-sale electronic payment system is configured to transmit the receipt information to the remote server/database for storage therein if the purchaser is verified as a subscribing consumer.

8. The system of claim 7, wherein the remote server database may be accessed by a subscribing consumer via the Internet, in order to retrieve the receipt information stored therein.

9. The system of claim 7, wherein a subscribing consumer may access the remote server database and use the receipt information stored therein to generate a paper receipt which may be downloaded to and printed on a local printer.

10. The system of claim 7, wherein the merchant may access the remote server database in order to retrieve an available subset of the receipt information, including information as to the purchaser's name, address, items purchased and e-mail or mailing address.

11. The system of claim 10, wherein the merchant may use the available subset of receipt information to track consumer purchases and provide electronic coupons.

12. The system of claim 7, wherein a subscribing consumer may access the remote server database and use the receipt information stored therein to generate a gift receipt, which may then be e-mailed to a gift recipient.

13. A method for generating and storing electronic receipt information which may then later be accessed by a purchaser, said method comprising:
pre-associating said purchaser with an account by accepting credit or debit card information entered by said user, truncating said credit or debit card information, and storing said truncated credit or debit card information in a database;
receiving truncated and encrypted credit or debit card information from a point-of-sale electronic payment system located at a merchant's point-of-purchase location;
decrypting the information received from the point-of-sale electronic payment system and comparing the decrypted information with the pre-associated truncated credit or debit card information previously stored; and
receiving additional electronic receipt information from the point of sale electronic payment system and storing it in the purchaser's account if the decrypted information matches the pre-associated truncated credit or debit card information previously stored.

14. The method of claim 13, further comprising the additional steps of:
generating a header from said electronic receipt information; and
inserting said header into a chronological listing of headers, all of which are related to electronic receipt information for each purchase made by said purchaser.

15. The method of claim 14, further comprising the additional step of associating a detailed electronic receipt with each header in the listing.

16. The method of claim 15, further comprising the additional step of
providing the detailed electronic receipt to the purchaser so that it may be printed on a local printer in order to generate a paper receipt.

17. A system for initiating a product return using electronic receipt information related to the original purchase of said product, the system comprising:
a remote server/database in which the electronic receipt information related to the original purchase of said product has been previously stored,
a point-of-sale electronic payment system, resident at a point-of-purchase where the product to be returned was originally purchased; and
wherein the remote server database is configured to transmit the electronic receipt information to the point-of-sale electronic payment system when a user wishes to return the product.

18. The system of claim 17, wherein the remote server database may be accessed by a subscribing consumer via the Internet, in order to retrieve the electronic receipt information stored therein.

19. The system of claim 17, wherein a subscribing consumer may access the remote server database and use the receipt information stored therein to generate a paper receipt which may be downloaded to and printed on a local printer.

20. A method for initiating a product return using electronic receipt information related to the original purchase of said product, the method comprising:
retrieving electronic receipt information related to the original purchase of said product that has been previously stored at a remote server/database;
transmitting said electronic receipt information from the remote serve/database to a point-of-sale electronic payment system resident at a point-of-purchase where the product to be returned was originally purchased;
returning the product to the point-of-purchase; and
using the electronic receipt information to process and complete a return of the product.

21. The method of claim 20 comprising the further step of generating updated electronic receipt information at the point-of-purchase, said updated electronic receipt information indicating that the return of the product has been completed.

22. The method of claim 21, comprising the further steps of:
transmitting the updated electronic receipt information from the point-of-sale electronic payment system resident at the point-of-purchase to the remote server/database; and
storing the updated electronic receipt information at the remote server/database.

23. The method of claim 22, wherein the remote server/database may be accessed by a subscribing consumer via the Internet, in order to retrieve the updated electronic receipt information stored therein.

24. The method of claim 22, wherein a subscribing consumer may access the remote server/database and use the updated electronic receipt information stored therein in order to generate a paper receipt which may be downloaded to and printed on a local printer.
